(19) United States
(12) Patent Application Publication
(10) Pub. No.: US 2025/0275591 A1
(43) Pub. Date: Sep. 4, 2025

(54) QR Code Garment Device

(71) Applicant: Gary Sexton, Silver Springs, FL (US)

(72) Inventor: Gary Sexton, Silver Springs, FL (US)

(21) Appl. No.: 18/908,169

(22) Filed: Oct. 7, 2024

Related U.S. Application Data
(60) Provisional application No. 63/560,197, filed on Mar. 1, 2024.

(51) Int. Cl. A41D 1/00; G06K 19/06

(52) U.S. Cl. CPC A41D 1/002; G06K 19/06103

(57) ABSTRACT

A QR code garment device is disclosed, which is a line of T-shirts with QR codes and designs, so wearers can share custom content with everyone around them. The QR code garment device comprises a garment component that is configured in a conventional T-shirt shape or other suitable garment. Further, the garment component comprises a QR code printed on it. The QR code can be linked to custom content, allowing a user to share their interests with the world.

### CROSS-REFERENCE TO RELATED APPLICATION

The present application claims priority to, and the benefit of, U.S. Provisional Application No. 63/560,197, which was filed on Mar. 1, 2024, and is incorporated herein by reference in its entirety.

### FIELD OF THE INVENTION

The present invention relates generally to the field of QR code garment devices. More specifically, the present invention relates to an improved garment with a scannable QR code printed on it. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in QR code garment devices. Generally, graphic tees and other clothing are a great way to convey a message with images, but their space is limited. Further, users may wish to customize their tees and other clothing without ruining the garment.

Additionally, users may want a safer experience for sharing information without physically contacting or being contacted. The shared information can be marketing information, such as instant promotions and sales on the go, or can be safety information and can provide links to a child's parents contacts in case the child is lost. The information can be customizable to the user and can include memories of voice, video, audio, and photos. The invention has advanced the way clothing is worn and media is streamed forever by combining fabric and near field communication or quick response codes to bring a solution for sharing safely and speeding up the way media is shared.

Accordingly, there is a demand for an improved QR code garment device that incorporates graphic designs alongside QR codes. More particularly, there is a demand for a QR code garment device that allows users share a wide array of custom content, such as videos, emblems, and pictures, etc.

Therefore, there exists a long felt need in the art for a QR code garment device that provides users with a garment with a scannable QR code. There is also a long felt need in the art for a QR code garment device that incorporates graphic designs alongside QR codes. Further, there is a long felt need in the art for a QR code garment device that allows users to share a wide array of custom content, such as videos, emblems, and pictures, etc. Moreover, there is a long felt need in the art for a device that can highlight a user's interests. Further, there is a long felt need in the art for a QR code garment device that allows users to easily scan the code with a smart device. Finally, there is a long felt need in the art for a QR code garment device that offers stylish designs that are fun to wear.

The subject matter disclosed and claimed herein, in one embodiment thereof, comprises a QR code garment device. The device is a line of T-shirts with QR codes and designs, so wearers can share custom content with everyone around them. The QR code garment device comprises a garment component that is configured in a conventional T-shirt shape or other suitable garment. Further, the garment component comprises a QR code printed on it. The QR code can be linked to custom content, allowing a user to share their interests with the world.

In this manner, the QR code garment device of the present invention accomplishes all of the forgoing objectives and provides users with a garment that includes a QR code. The device can be any suitable garment. The QR code can link to a variety of information.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a QR code garment device. The device is a line of T-shirts with QR codes and designs, so wearers can share custom content with everyone around them. The QR code garment device comprises a garment component that is configured in a conventional T-shirt shape or other suitable garment. Further, the garment component comprises a QR code printed on it. The QR code can be linked to custom content, allowing a user to share their interests with the world.

In one embodiment, the QR code garment device allows a user to share custom content with everyone around them. Graphic tees are a great way to convey a message with images, however their space is limited. The device features fun designs paired with QR codes, so wearers can say more with what they wear. Thus, the present invention is scannable clothing by combining fabric materials and Near field communication or Quick response codes to allow the user contactless sharing of any audio, video, website, contact information, locations and images, etc.

In one embodiment, the QR code garment device allows a safer experience for the user to share without physically contacting or being contacted. Accordingly, the scannable garment is an advance form of marketing, allowing the user to receive instant promotion and sales on the go. Further, the invention is designed to make memories last a lifetime with scannable memories of voice, video, audio, and photo's, etc. Thus, the invention has advanced the way clothing is worn and media is streamed forever by combining fabric and near field communication or quick response codes to bring a solution for sharing safely and speeding up the way media is shared.

In one embodiment, the QR code garment device comprises a garment component. The garment component can be any suitable garment as is known in the art, such as a tee shirt, sweatshirt, shorts, pants, jeans, socks, hats, etc. Further, the garment component comprises an exterior surface and an interior surface. The exterior surface of the garment component is further comprised of at least one QR code or any suitable unique, scannable code as is known in the art. In various embodiments, the QR code may be an adhesive sticker that can be pressed onto the exterior surface of the garment component, or can be silk-screened, embossed, printed, or overlayed over the exterior surface of the garment component as a permanent feature of the garment component, etc., or may be in the form of a paper-based card or tag that is connected to the garment component and can be removed when the garment component is worn. Accordingly, the QR code shall be printed or embedded on users' jacket, t-shirts or other wearable garments. The same could also be embedded on bracelets for use. The QR code can be advertised with an enticement to scan for different media or just be shown by itself beside the graphic design.

In one embodiment, the QR code is provided on a garment component, such as a theme-based jacket, t-shirt or any other related garment that has a decorative design. The decorative area is sub-divided into an inner area with the QR code and an outer area adjacent to the inner area and that partially surrounds this inner area. In the outer area, the decorative design has an exterior design which can incorporate the QR code or be completely separate from the QR code. Placement of the QR code on the wearable items is done such that others are able to easily and efficiently scan the QR code from a mobile computing device and access the custom content.

In one embodiment, the format of the QR code is a square matrix of black and white or any other color in form of small squares, surrounded by a white border. It can be 21 by 21, 25 by 25 and bigger. Usually, format 25 is enough to encode a short URL on a 7% error correction level. Although format 21 is better in terms of real-life conditions, the scan ability may be limited in the number of combinations available.

In one embodiment, the QR code contains encoded data, including information about the interest and hobbies of the user (or wearer). A person sees the shirt and scans the QR code using a scanning device such as a scanner or a smartphone with scanning capabilities. The scanned QR code launches a web browser or application using the phone's network connection or wireless Internet to connect to a server. The server receives the data encoded in the QR code, decodes the QR Code data, parses the data, and then displays the user selected data from the QR code on the person's phone screen.

In one embodiment, custom content and data can be uploaded to the QR code and then appended to a Uniform Resource Locator (URL) that contains information required to access a server. The appended data conforms to the URL standard and thus forms part of a longer URL. Once a user uploads their custom content, they can allow others to scan the QR code and access the custom content. Further, the QR code, i.e., a Quick Response code, is a two-dimensional barcode that shall be present on the garments or other wearable items of the user, which would be read, i.e., by correspondingly equipped cellular phones or other mobile computing devices. The invention is based on accessing multiple data and custom content through the QR code.

In another embodiment, after being scanned by their smart devices, the QR code would grant others access to the custom content uploaded by the user. In one or more aspects of the present invention, a user's electronic computing device (i.e., smart device) is utilized to access the custom content, by scanning the QR code present on the garment component, such that after being scanned, the QR code redirects the operating system of the smart device to a secondary digital location where the custom content is stored.

In one embodiment, the secondary digital location may be a social media page of the wearer or other relevant individual or group of persons related to the wearer. Said individual/group may include, but is not limited to, an individual, a group, a team, a celebrity, an artist, a pop-culture figure, a company, an organization, a business, a fictional character, a brand, etc., that the wearer owns, endorses, supports, or has interests in, etc.

In a differing embodiment, the secondary digital location may be a music-related page, such as a music-playing mobile application page or a music website of a relevant individual or group of persons related to the wearer or of interest to the wearer.

In a further embodiment, the secondary digital location may be a website. Said website may be a consumer website that allows users a chance to purchase a product sold by the individual, group of persons, or company related to the wearer, or may be a custom website set up by the user and tailored to their own interests and hobbies.

Accordingly, the QR code garment device of the present invention is particularly advantageous as it provides a device that allows custom content to be linked to a garment. After purchasing the garment component, users can upload custom content, such as videos, emblems, music, photos, pictures, etc., or any other suitable custom content as is known in the art. Thus, the custom content can include a wearer's interests with the world, from sports, to fishing, hunting, vacations, favorite bands, albums, movies, etc. Users can then wear the garment component in public and allow people to scan and download the custom content from the QR code.

One of the invention's objectives is to provide a new style of wearable garments embedded with technology. A QR Code on the jacket or T-shirt helps the user to stand out from the crowd. It does not only make the garment different but also adds the element of technology to it. Hence, it attracts attention from others, causing others to want to scan the QR code.

In yet another embodiment, the QR code garment device comprises a plurality of indicia.

In yet another embodiment, a method of scanning a QR code to obtain additional information is disclosed. The method includes the steps of providing a QR code garment device comprising a garment component with a QR code. The method also comprises selecting a specific garment component with a QR code. Further, the method comprises uploading custom content to the QR code. The method also comprises wearing the garment component in public. Finally, the method comprises allowing users to scan the QR code to access the custom content.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrate a perspective view of one embodiment of the QR code garment device of the present invention showing the front of the shirt in accordance with the disclosed architecture;

FIG. 2 illustrates a perspective view of one embodiment of the QR code garment device of the present invention showing the back of the shirt in accordance with the disclosed architecture;

FIG. 3 illustrates a perspective view of one embodiment of the QR code garment device of the present invention showing the shirt graphic design in accordance with the disclosed architecture;

FIG. 4 illustrates a perspective view of one embodiment of the QR code garment device of the present invention showing the graphic design incorporating the QR code in accordance with the disclosed architecture;

FIG. 5 illustrates a perspective view of one embodiment of the QR code garment device of the present invention showing the device in use on a garment in accordance with the disclosed architecture; and

FIG. 6 illustrates a flowchart showing the method of scanning a QR code to obtain additional information in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a QR code garment device that provides users with a garment with a scannable QR code. There is also a long felt need in the art for a QR code garment device that incorporates graphic designs alongside QR codes. Further, there is a long felt need in the art for a QR code garment device that allows users to share a wide array of custom content, such as videos, emblems, and pictures, etc. Moreover, there is a long felt need in the art for a device that can highlight a user's interests. Further, there is a long felt need in the art for a QR code garment device that allows users to easily scan the code with a smart device. Finally, there is a long felt need in the art for a QR code garment device that offers stylish designs that are fun to wear.

The present invention, in one exemplary embodiment, is a novel QR code garment device. The QR code garment device comprises a garment component that is configured in a conventional T-shirt shape or other suitable garment. Further, the garment component comprises a QR code printed on it. The QR code can be linked to custom content, allowing a user to share their interests with the world. The present invention also includes a novel method of scanning a QR code to obtain additional information. The method includes the steps of providing a QR code garment device comprising a garment component with a QR code. The method also comprises selecting a specific garment component with a QR code. Further, the method comprises uploading custom content to the QR code. The method also comprises wearing the garment component in public. Finally, the method comprises allowing users to scan the QR code to access the custom content.

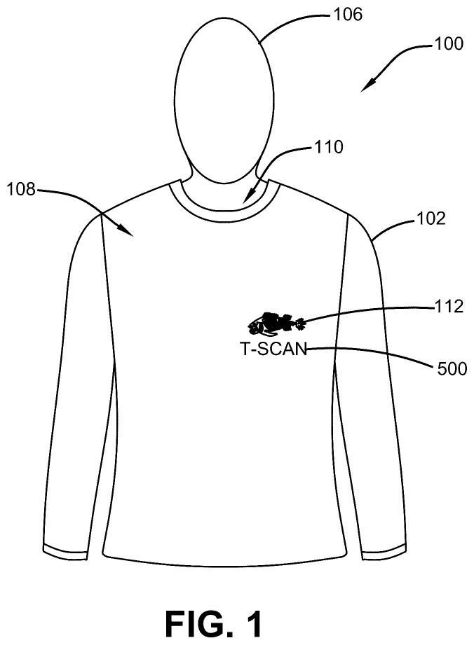

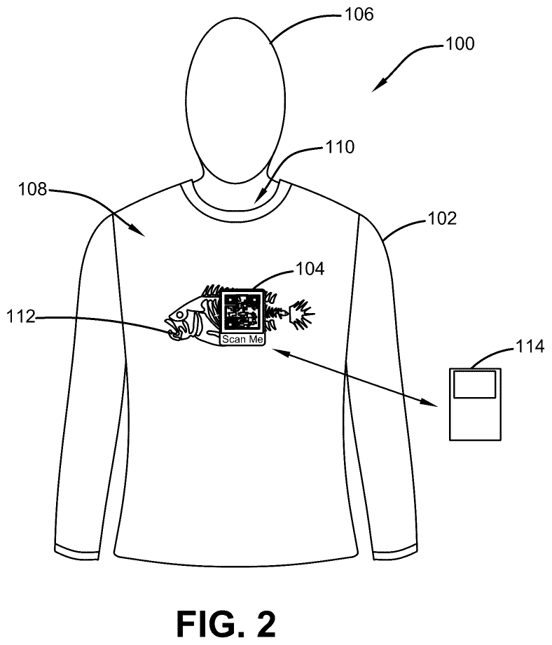

Referring initially to the drawings, FIGS. 1-2 illustrate a perspective view of one embodiment of the QR code garment device 100 of the present invention. In the present embodiment, the QR code garment device 100 is an improved QR code garment device 100 that incorporates graphic designs alongside QR codes on garments. Specifically, the QR code garment device 100 comprises a garment component 102 with a QR code 104. The QR code 104 can be linked to custom content, allowing a user 106 to share their interests with the world.

Generally, the QR code garment device 100 allows a user 106 to share custom content with everyone around them. Graphic tees are a great way to convey a message with images, however their space is limited. The device 100 features fun designs paired with QR codes 104, so wearers 106 can say more with what they wear. Thus, the present invention is scannable clothing by combining fabric materials and Near field communication or Quick response codes 104 to allow the user 106 contactless sharing of any audio, video, website, contact information, locations and images, etc.

Further, the QR code garment device 100 allows a safer experience for the user 106 to share without physically contacting or being contacted. Accordingly, the scannable garment is an advance form of marketing, allowing the user 106 to receive instant promotion and sales on the go. Further, the invention is designed to make memories last a lifetime with scannable memories of voice, video, audio, and photo's, etc. Thus, the invention has advanced the way clothing is worn and media is streamed forever by combining fabric and near field communication or quick response codes to bring a solution for sharing safely and speeding up the way media is shared.

Additionally, the QR code garment device 100 comprises a garment component 102. The garment component 102 can be any suitable garment as is known in the art, such as a tee shirt, sweatshirt, shorts, pants, jeans, socks, hats, etc. Further, the garment component 102 comprises an exterior surface 108 and an interior surface 110. The exterior surface 108 of the garment component 102 is further comprised of at least one QR code 104 or any suitable unique, scannable code as is known in the art. In various embodiments, the QR code 104 may be an adhesive sticker that can be pressed onto the exterior surface 108 of the garment component 102, or can be silk-screened, embossed, printed, or overlayed over the exterior surface 108 of the garment component 102 as a permanent feature of the garment component 102, etc., or may be in the form of a paper-based card or tag that is connected to the garment component 102 and can be removed when the garment component 102 is worn. Accordingly, the QR code 104 shall be printed or embedded on users' jacket, t-shirts or other wearable garments 102. The same could also be embedded on bracelets for use. The QR code 104 can be advertised with an enticement to scan for different media or just be shown by itself beside the graphic design 112.

Furthermore, the QR code 104 is provided on a garment component 102, such as a theme-based jacket, t-shirt or any other related garment 102 that has a decorative design 112. The decorative area is sub-divided into an inner area with the QR code 104 and an outer area adjacent to the inner area and that partially surrounds this inner area. In the outer area, the decorative design 112 has an exterior design which can incorporate the QR code 104 or be completely separate from the QR code 104. Placement of the QR code 104 on the wearable items is done such that others are able to easily and efficiently scan the QR code 102 from a mobile computing device 114 and access the custom content.

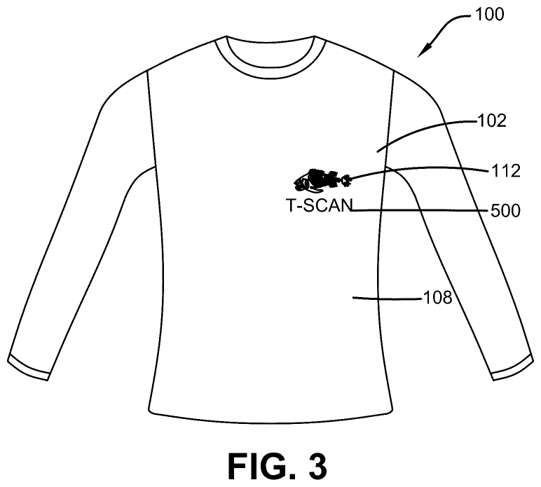

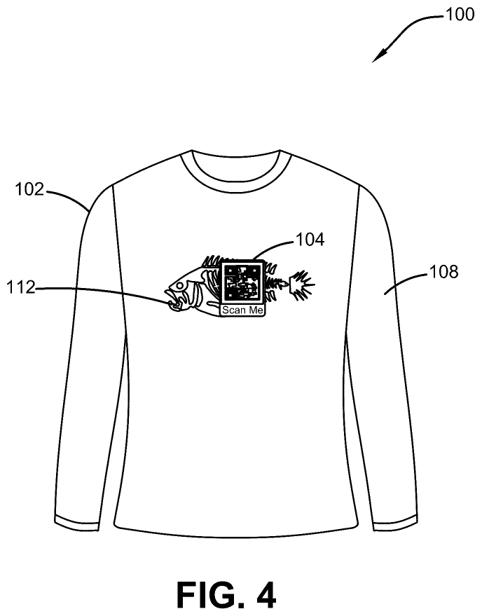

As shown in FIGS. 3-4, the format of the QR code 104 is a square matrix of black and white or any other color in form of small squares, surrounded by a white border. It can be 21 by 21, 25 by 25 and bigger. Usually, format 25 is enough to encode a short URL on a 7% error correction level. Although format 21 is better in terms of real-life conditions, the scan ability may be limited in the number of combinations available.

Typically, the QR code 104 contains encoded data, including information about the interest and hobbies of the user (or wearer) 106. A person sees the shirt and scans the QR code 104 using a scanning device 114 such as a scanner or a smartphone with scanning capabilities. The scanned QR code launches a web browser or application using the phone's network connection or wireless Internet to connect to a server. The server receives the data encoded in the QR code 104, decodes the QR Code data, parses the data, and then displays the user selected data from the QR code 104 on the person's phone screen.

Furthermore, custom content and data can be uploaded to the QR code 104 and then appended to a Uniform Resource Locator (URL) that contains information required to access a server. The appended data conforms to the URL standard and thus forms part of a longer URL. Once a user 106 uploads their custom content, they can allow others to scan the QR code 104 and access the custom content. Further, the QR code 104, i.e., a Quick Response code, is a two-dimensional barcode that shall be present on the garments 102 or other wearable items of the user 106, which would be read, i.e., by correspondingly equipped cellular phones 114 or other mobile computing devices. The invention is based on accessing multiple data and custom content through the QR code 104.

Additionally, after being scanned by their smart devices 114, the QR code 104 would grant others access to the custom content uploaded by the user 106. In one or more aspects of the present invention, a user's electronic computing device (i.e., smart device 114) is utilized to access the custom content, by scanning the QR code 104 present on the garment component 102, such that after being scanned, the QR code 104 redirects the operating system of the smart device 114 to a secondary digital location where the custom content is stored.

In one embodiment, the secondary digital location may be a social media page of the wearer 106 or other relevant individual or group of persons related to the wearer 106. Said individual/group may include, but is not limited to, an individual, a group, a team, a celebrity, an artist, a pop-culture figure, a company, an organization, a business, a fictional character, a brand, etc., that the wearer 106 owns, endorses, supports, or has interests in, etc.

In a differing embodiment, the secondary digital location may be a music-related page, such as a music-playing mobile application page or a music website of a relevant individual or group of persons related to the wearer 106 or of interest to the wearer 106.

In a further embodiment, the secondary digital location may be a website. Said website may be a consumer website that allows users 106 a chance to purchase a product sold by the individual, group of persons, or company related to the wearer 106, or may be a personal website set up by the user 106 and tailored to their own interests and hobbies and does not necessarily have to offer any items for sale.

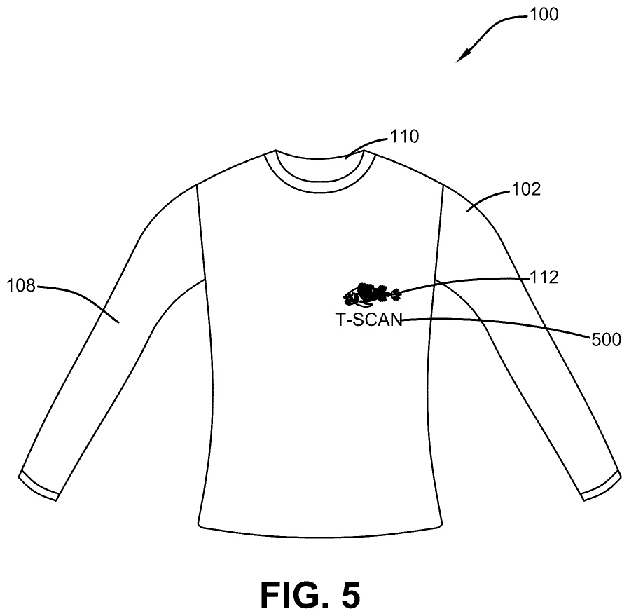

As shown in FIG. 5, the QR code garment device 100 of the present invention is particularly advantageous as it provides a device 100 that allows custom content to be linked to a garment 102. After purchasing the garment component 102, users 106 can upload custom content, such as videos, emblems, music, photos, pictures, etc., or any other suitable custom content as is known in the art. Thus, the custom content can include a wearer's interests with the world, from sports, to fishing, hunting, vacations, favorite bands, albums, movies, etc. Users 106 can then wear the garment component 102 in public and allow people to scan and download the custom content from the QR code 104.

One of the invention's objectives is to provide a new style of wearable garments embedded with technology. A QR Code 104 on the jacket or T-shirt helps the user 106 to stand out from the crowd. It does not only make the garment 102 different but also adds the element of technology to it. Hence, it attracts attention from others, causing others to want to scan the QR code 104.

In yet another embodiment, the QR code garment device 100 comprises a plurality of indicia 500. The garment component 102 of the device 100 may include advertising, a trademark, or other letters, designs, or characters, printed, painted, stamped, or integrated into the garment component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be tee shirt, QR code, or brand related.

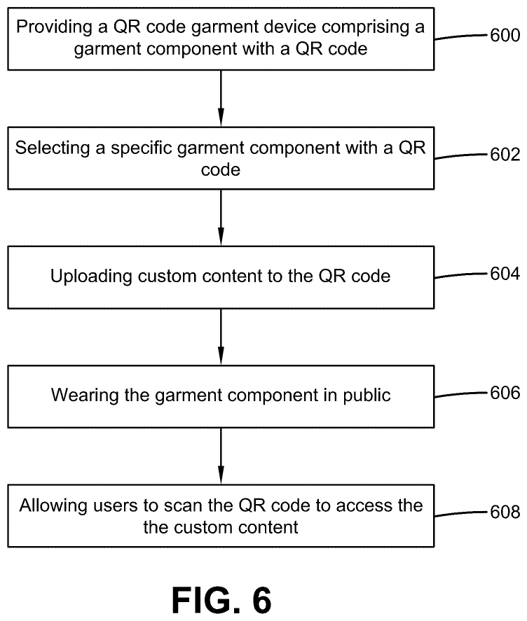

FIG. 6 illustrates a flowchart of the method of scanning a QR code to obtain additional information. The method includes the steps of at 600, providing a QR code garment device comprising a garment component with a QR code. The method also comprises at 602, selecting a specific garment component with a QR code. Further, the method comprises at 604, uploading custom content to the QR code. The method also comprises at 606, wearing the garment component in public. Finally, the method comprises at 608, allowing users to scan the QR code to access the custom content.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “QR code garment device”, “QR code device”, “garment device”, and “device” are interchangeable and refer to the QR code garment device 100 of the present invention.

Notwithstanding the forgoing, the QR code garment device 100 of the present invention can be of any suitable size and configuration as is known in the art without affecting the overall concept of the invention, provided that it accomplishes the above stated objectives. One of ordinary skill in the art will appreciate that the QR code garment device 100 as shown in FIGS. 1-6 is for illustrative purposes only, and that many other sizes and shapes of the QR code garment device 100 are well within the scope of the present disclosure. Although the dimensions of the QR code garment device 100 are important design parameters for user convenience, the QR code garment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A QR code garment device that incorporates graphic designs with QR codes on garments, the QR code garment device comprising:
a garment component; and
a QR code;
wherein the QR code is applied to the garment component;
wherein the QR code can be scanned for data; and
further wherein the QR code contains custom content provided by a user wearing the garment component, allowing the user to share their interests with world.

2. The QR code garment device of claim 1, wherein the QR code garment device allows a safe experience for the user to share custom content without physically contacting or being contacted.

3. The QR code garment device of claim 2, wherein the garment component can be a tee shirt, sweatshirt, shorts, pants, jeans, socks or hats.

4. The QR code garment device of claim 3, wherein the garment component comprises an exterior surface and an interior surface.

5. The QR code garment device of claim 4, wherein the exterior surface of the garment component comprises at least one QR code.

6. The QR code garment device of claim 5, wherein the at least one QR code is applied to a front side of the exterior surface.

7. The QR code garment device of claim 6, wherein the at least one QR code is applied to a back side of the exterior surface.

8. The QR code garment device of claim 7, wherein the at least one QR code is applied to both the front side and the back side of the exterior surface.

9. The QR code garment device of claim 8, wherein the at least one QR code is silk-screened, embossed, printed, or overlayed over the exterior surface of the garment component.

10. The QR code garment device of claim 9, wherein the at least one QR code is scanned via a smart device.

11. The QR code garment device of claim 10, wherein after being scanned by the smart device, the QR code would grant others access to the custom content uploaded by the user.

12. The QR code garment device of claim 11, wherein after being scanned, the QR code redirects operating system of the smart device to a secondary digital location where the custom content is stored.

13. The QR code garment device of claim 12, wherein the secondary digital location may be a social media page of the user, a music-related page, a website selling a product, or a personal website set up by the user and tailored to their own interests and hobbies and does not necessarily have to offer any items for sale.

14. A QR code garment device that incorporates graphic designs with QR codes on garments, the QR code garment device comprising:
a garment component with a decorative design, such as a tee shirt, sweatshirt, shorts, pants, jeans, socks or hats; and
a QR code containing custom content from a user;
wherein the garment component comprises an exterior surface and an interior surface;
wherein the QR code is applied to the exterior surface of the garment component;
wherein the QR code is silk-screened, embossed, printed, or overlayed over the exterior surface of the garment component;
wherein the QR code can be scanned via a smart device;
wherein after being scanned by the smart device, the QR code would grant others access to the custom content uploaded by the user;
wherein after being scanned, the QR code redirects operating system of the smart device to a secondary digital location where the custom content is stored; and
further wherein the secondary digital location may be a social media page of the user, a music-related page, a website selling a product, or a personal website set up by the user and tailored to their own interests and hobbies and does not necessarily have to offer any items for sale.

15. The QR code garment device of claim 14, wherein the decorative design of the garment component incorporates the QR code or is completely separate from the QR code.

16. The QR code garment device of claim 14, wherein placement of the QR code on the garment component is done such that others are able to easily and efficiently scan the QR code from a smart device.

17. The QR code garment device of claim 14, wherein after purchasing the garment component, users can upload custom content, such as videos, emblems, music, photos, or pictures depicting user's hobbies and interests.

18. The QR code garment device of claim 14 further comprising a plurality of indicia.

19. The QR code garment device of claim 14, wherein the QR code is applied to both a front side and a back side of the exterior surface of the garment component.

20. A method of scanning a QR code to obtain additional information, the method comprising the following steps:
providing a QR code garment device comprising a garment component with a QR code;
selecting a specific garment component with a QR code;
uploading custom content to the QR code;
wearing the garment component in public; and
allowing users to scan the QR code to access the custom content.
